(19) United States
(12) Patent Application Publication
(10) Pub. No.: US 2026/0257243 A1
(43) Pub. Date: Sep. 3, 2026

(54) VIBRATION AND SOUND APPARATUS INTEGRATED ACTUATOR

(71) Applicant: ACTUWARD. CO. LTD., Suwon-si (KR)

(72) Inventor: Dong-Man KIM, Seoul (KR)

(73) Assignee: ACTUWARD. CO. LTD., Suwon-si (KR)

(21) Appl. No.: 19/549,008

(22) Filed: Feb. 25, 2026

(30) Foreign Application Priority Data
Feb. 25, 2025 (KR) 10-2026-0034759

(51) Int. Cl. B06B 1/04; H02K 33/02

(52) U.S. Cl. CPC B06B 1/045; H02K 33/02; H02K 2203/06

(57) ABSTRACT

The present invention relates to a vibration sound device, and more particularly, to an actuator-integrated vibration sound device in which a magnetic circuit and a medium plate are integrated. According to an embodiment of the present disclosure, an actuator-integrated vibration sound device includes: an actuator assembly including a magnetic circuit disposed therein and configured to generate vertical vibration of an actuator; a first medium plate connected to a lower portion of the actuator assembly and configured to transmit vibration from the actuator; a second medium plate spaced a predetermined distance from the first medium plate; and a middle case having one end connected to the first medium plate and the other end connected to the second medium plate.

### CROSS-REFERENCE TO RELATED APPLICATIONS

This US non-provisional patent application claims priority under 35 USC §119 of Korean Patent Application No. 10-2026-0034759, filed on February 25, 2026, the entire contents of which are hereby incorporated by reference.

### BACKGROUND

The present invention relates to a vibration sound device, and more particularly, to an actuator-integrated vibration sound device in which a magnetic circuit and a medium plate are integrated.

A vibration driver refers to a device for transmitting vibration to an object to be vibrated, and a speaker refers to a device for converting vibration into sound.

The vibration driver and the speaker have the same operation principle. Depending on the configuration of a magnetic circuit, an induced electromotive force is generated according to Fleming’s left-hand rule and the Lorentz force, such that a device in which a coil plate vibrates vertically and is converted into sound serves as a speaker, and a device in which a magnetic body vibrates vertically by a fixed coil plate to transmit vibration serves as a vibration actuator.

Korean Patent Registration No. 10-1469555 discloses a 'VIBRATION SPEAKER', which is attached to an artificial structure and transmits sound and vibration together.

Although the vibration speaker includes a plate-shaped mastoid that delivers sound or vibration to the artificial structure by using a magnetic body including a magnet and a voice coil, the vibration speaker has similar limitations to those of the above-described cone-type vibration driver in terms of a circular vibration structure.

To solve such conventional problems, the present applicant developed 'FLAT TYPE VIBRATION DRIVER' of Korean Patent Registration No. 10-2186836 and 'HYBRID COIL PLATE, FLAT-TYPE SPEAKER AND VIBRATION DRIVER USING THE SAME' of Korean Patent Registration No. 10-2916252, and obtained patent registrations therefor. However, demands for improved quality through miniaturization of vibration devices with the miniaturization of electronic devices, waterproof and dustproof characteristics suitable for outdoor applications, and minimization of sound distortion have increased. Accordingly, there is a need to actively respond to such demands.

### RELATED ART DOCUMENT

### Patent Document

(Patent document 1) Korean Patent Registration No. 10-1469555

(Patent document 2) Korean Patent Registration No. 10-2186836

(Patent document 3) Korean Patent Registration No. 10-2916252

### SUMMARY

The present invention provides an outdoor-type vibration and sound device.

The present invention also provides a vibration and sound device in which sound distortion is not generated through a structure in which a medium plate and a magnetic circuit are integrally coupled, and in which a role as a passive radiator is induced through boxing of front and rear medium plates.

The present invention also provides an ultra-slim vibration and sound device having a haptic function that actively responds to development of various haptic device products that implement tactile sensation, such as a haptic glove.

Technical objects to be solved by the present invention are not limited to the aforementioned technical objects and unmentioned technical objects will be clearly understood by those skilled in the art to which the present invention belongs.

An embodiment of the present disclosure provides an actuator-integrated vibration sound device including: an actuator assembly including a magnetic circuit disposed therein and configured to generate vertical vibration of an actuator; a first medium plate connected to a lower portion of the actuator assembly and configured to transmit vibration from the actuator; a second medium plate spaced a predetermined distance from the first medium plate; and a middle case having one end connected to the first medium plate and the other end connected to the second medium plate.

In an embodiment, the first and second medium plates and the middle case may be connected via first and second rubber edges, respectively.

In an embodiment, a plurality of linear ribs or radial ribs may be disposed on opposing surfaces of the first and second medium plates.

In an embodiment, a coil plate connector into which a coil plate of the actuator is fitted may be disposed on one surface of the first medium plate, a lead wire terminal electrically connected to the coil plate connector may be provided, and a lead plate configured to apply external power may be coupled to the lead wire terminal.

In an embodiment, the actuator may include a pair of opposing magnet parts and a coil plate disposed therebetween in an upright manner, both ends of each of the pair of magnet parts may be fitted into and coupled to the assembly, and a metal suspension coupled to the assembly may be provided to transmit vibration to both sides.

In an embodiment, the actuator assembly may have a lower portion in contact with the first medium plate and an upper portion covered by a cover plate and may include an actuator disposed therein and a side case disposed on an outer side thereof.

In an embodiment, a plurality of column posts having screw taps may be disposed on one surface of the first medium plate, and connection posts may be disposed on a bottom surface of the cover plate at positions corresponding to the column posts.

In an embodiment, left and right metal suspensions configured to transmit vibration may be disposed on both sides of the actuator, a first fastening portion may be disposed at a central portion of each of the metal suspensions, and a second fastening portion may be disposed on an inner side of the side case at a position corresponding to the first fastening portion, and a connecting ring into which a column bolt is insertable may be disposed on the inner side of the side case between the column posts and the connection posts.

In an embodiment, the first and second medium plates and the middle case may be connected via first and second rubber edges, respectively, to seal an internal predetermined space, and the second medium plate may serve as a passive radiator due to compression and expansion of air within the internal space caused by vibration of the first medium plate according to vertical vibration of the actuator.

In an embodiment of the present invention, an actuator-integrated vibration sound device includes: an actuator assembly including a side case surrounding an exterior of the actuator assembly and having a lower portion in contact with the first medium plate and an upper portion covered by a cover plate, and an actuator disposed in the side case and including a magnetic circuit including a pair of opposing magnet parts and a coil plate disposed therebetween in an upright manner and metal suspensions disposed on left and right sides thereof and configured to transmit vertical vibration of the pair of magnet parts; and a medium plate connected to a lower portion of the actuator assembly and made of a plate-shaped plastic material having elasticity, the medium plate being configured to integrally transmit vibration from the actuator.

### BRIEF DESCRIPTION OF THE FIGURES

The accompanying drawings are included to provide a further understanding of the present disclosure, and are incorporated in and constitute a part of this specification. The drawings illustrate embodiments of the present disclosure and, together with the description, serve to explain principles of the present disclosure. In the drawings:

FIG. 1 is a perspective view illustrating an actuator-integrated vibration sound device according to an embodiment of the present invention;

FIG. 2 is an exploded perspective view illustrating the actuator-integrated vibration sound device according to an embodiment of the present invention;

FIG. 3 is a structural view illustrating an actuator of the actuator-integrated vibration sound device according to an embodiment of the present invention;

FIG. 4 is a cross-sectional view illustrating an integrally assembled state of the actuator-integrated vibration sound device according to an embodiment of the present invention;

FIG. 5 is a cross-sectional view illustrating a connection between the actuator and a medium plate of the actuator-integrated vibration sound device according to an embodiment of the present invention; and

FIG. 6 is a structural view of first and second medium plates of the actuator-integrated vibration sound device according to an embodiment of the present invention.

### DETAILED DESCRIPTION

Hereinafter, a structure and operational effects of the actuator-integrated vibration sound device according to the present invention will be described with reference to the accompanying drawings.

The detailed description on the specific embodiment illustrated in the accompanying drawings should be read in relation with the accompanying drawings, and the drawings are regarded as a part of the description of the entire invention. The terminology used herein is for the purpose of describing particular embodiments only and is not intended to be limiting of the invention.

Spatially relative terms, such as "beneath", "below", "lower", "above", "upper" and the like, may be used herein for ease of description to describe one element or feature's relationship to another element(s) or feature(s) as illustrated in the figures. It will be understood that the spatially relative terms are used for convenience of description and are not intended to limiting of the invention.

Note that the same or similar components in the drawings are designated by the same reference numerals as far as possible even if they are shown in different drawings. In the following description of the present invention, a detailed description of known functions and configurations incorporated herein will be omitted to avoid making the subject matter of the present invention unclear.

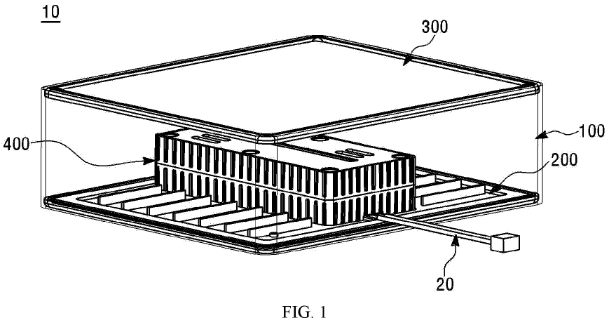

FIG. 1 is a perspective view illustrating an actuator-integrated vibration sound device according to an embodiment of the present invention.

Referring to FIG. 1, a vibration sound device 10 may include a middle case 100, first and second medium plates 200 and 300, and an actuator assembly 400.

The middle case 100 may have an external case structure having a predetermined shape. The first and second medium plates 200 and 300 may be mounted on upper and lower portions of the middle case 100, respectively. The actuator assembly 400 may be integrally embedded at a central portion of the first medium plate 200.

Although the middle case 100 is illustrated as being transparent for the purpose of showing an internal structure, the embodiment of the present invention is not limited thereto. For example, the middle case 100 may be made of either a transparent material or an opaque material.

A component of an actuator, which forms a magnetic circuit, may be embedded in the actuator assembly 400, and a lead plate 20 may be connected to a side portion of the actuator assembly 400 to apply power to the magnetic circuit.

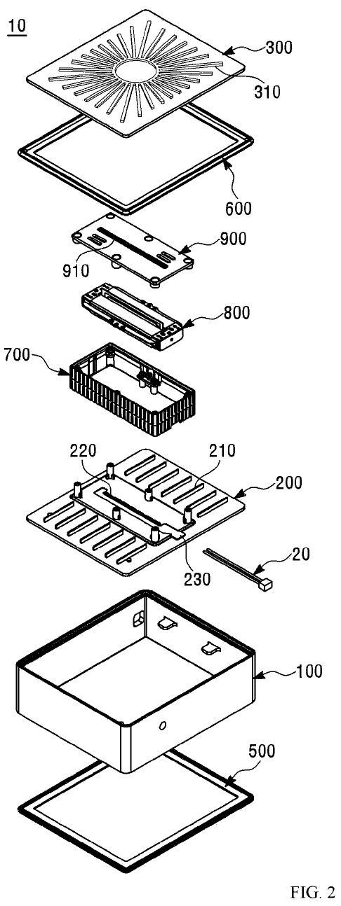

FIG. 2 is an exploded perspective view illustrating the actuator-integrated vibration sound device according to an embodiment of the present invention.

As illustrated in FIG. 2, the actuator-integrated vibration sound device 10 according to an embodiment of the present invention may include the middle case 100, the first and second medium plates 200 and 300, and the actuator assembly 400.

The middle case 100 is a case for protecting internal modules. Although the middle case 100 may have a rectangular parallelepiped shape, the embodiment of the present invention is not limited thereto.

The first and second medium plates 200 and 300 may be made of a plate-shaped material that is lightweight, rigid, and has excellent elasticity, and preferably may be made of an injection-molded plastic material.

The actuator assembly 400 including an actuator 800 is integrally coupled to the first medium plate 200, so that vibration generated within the actuator 800 is directly transmitted to the first medium plate 200, thereby enhancing a wave radiation function of the first medium plate 200 caused by vibration of the actuator 800 and preventing sound distortion.

In addition, a structure in which a coil plate 820 is directly and firmly integrally attached to the first medium plate 200 together with the actuator 800 may allow long-term use and secure durability.

A linear rib 210 extending in a horizontal direction and a radial rib 310 may be disposed on an inner surface of each of the first and second medium plates 200 and 300.

However, the shapes of the ribs is not limited thereto. For example, the shapes of the ribs may be formed to reduce the weight of the medium plates while increasing strength and elasticity thereof, and to prevent divided vibration of the medium plates.

The first and second medium plates 200 and 300 may be connected to upper and lower ends of the middle case 100 through first and second rubber edges 500 and 600.

By reinforcing the first and second rubber edges 500 and 600, smooth vibration of the first and second medium plates 200 and 300 is led, and transmission of vibration of the first and second medium plates 200 and 300 to the middle case 100 is prevented, thereby preventing sound distortion due to unnecessary vibration.

The actuator assembly 400 may include a side case 700 for protecting and supporting the actuator 800, the actuator 800 constituting a magnetic circuit, and a cover plate 900 connected to an upper portion of the side case 700 to fix one side of a coil plate 820.

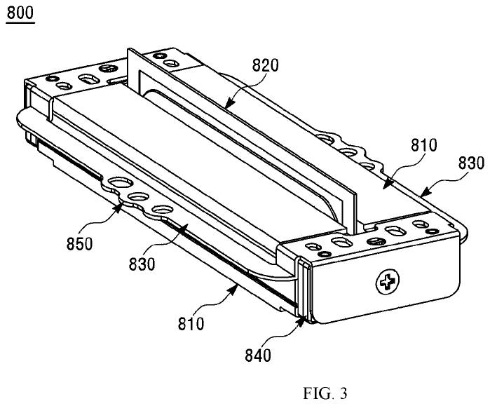

FIG. 3 is a structural view illustrating an actuator of the actuator-integrated vibration sound device according to an embodiment of the present invention.

Referring to FIG. 3, the actuator 800 may include a magnet part 810, a coil plate 820, a metal suspension 830, and an assembly 840.

The magnet parts 810 may be fitted into the assemblies 840 at both ends, respectively, and the metal suspension 830 may be fastened along a periphery thereof.

The magnet part 810 and the coil plate 820 may constitute a magnetic circuit.

According to the configuration of the magnetic circuit, an induced electromotive force is generated by Fleming’s left-hand rule and the Lorentz force, and the magnet part 810 is vertically vibrated by the coil plate 820 having a lower end fixed to the first medium plate 200.

Since the magnet part 810 is connected to the side case 700 through the metal suspension 830, vertical vibration of the actuator assembly 400 is directly transmitted to the first medium plate 200, thereby enabling vibration transmission and sound generation by the first medium plate 200.

The vibration sound device 10 may transmit sound and may also be attached to an object to transmit vibration thereto.

Here, the object refers to an article requiring a vibration effect according to sound, and may include, for example, a vibration chair for providing a 4D effect in a theater, clothing or gloves related to games in a 4D game industry, objects requiring vibration in an experience hall, and wearable devices having a 4D vibration mechanism.

The magnetic circuit includes a pair of magnet parts 810 spaced a predetermined distance from each other and facing each other, and a coil plate 820 disposed between the pair of magnet parts 810.

The pair of opposing magnet parts 810 may have identical configurations, and each may include a magnet and upper and lower yoke plates disposed on upper and lower surfaces of the magnet.

The magnets disposed in the magnetic circuit, which face each other, may have opposite polarities to act an attractive force therebetween, and the coil plate 820 may maintain the same distance from the magnetic parts 810 disposed at both sides to receive the same magnetic force.

Here, the coil plate 820 has one end fixed to the first medium plate 200 and the other end passing through an insertion hole 910 of the cover plate 900. As one end of the coil plate 820 is fixed to the first medium plate 200, the magnet parts 810 on both sides vertically vibrate.

The coil plate 820 may be a PCB (Printed Circuit Board) or an FPCB, and coils may be patterned in a track form on a single surface, both surfaces, or multiple stacked layers thereof.

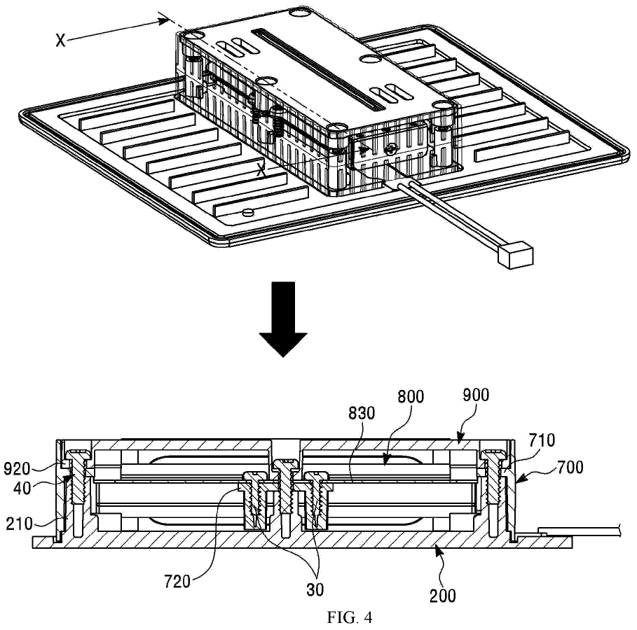

FIG. 4 is a cross-sectional view illustrating an integrally assembled state of the actuator-integrated vibration sound device according to an embodiment of the present invention.

FIG. 4 illustrates a cross-section taken along line X–X in a state in which the middle case 100 and the second medium plate 300 are removed.

Referring to FIG. 4, a plurality of column posts 210 may be formed on an inner central surface of the first medium plate 200, and screw taps may be formed therein for fastening.

Connection posts 920 may be formed on a bottom surface of the cover plate 900 at positions corresponding to the column posts 210.

First fastening portions 830 for connection may be disposed at central portions of both sides of the metal suspension 830, and second fastening portions 720 may be disposed on inner sides of the side case 700 at positions corresponding thereto.

A plurality of bolt holes may be defined in the first fastening portions 830, and bolt holes for connection with the cover plate 900 and screw taps for fastening suspension bolts 30 for coupling the metal suspension 830 may be provided in the second fastening portions 720.

At corners of the side case 700, connecting rings 710 may be provided between the column posts 210 and the connection posts 920, into which column bolts 40 may be inserted.

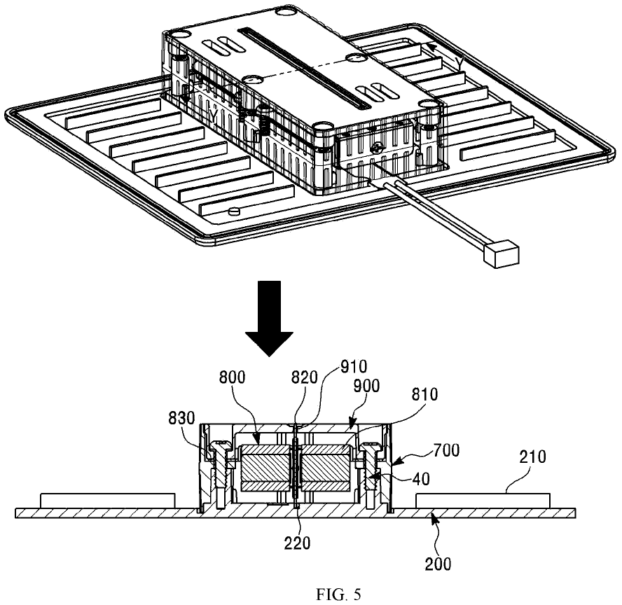

FIG. 5 is a cross-sectional view illustrating a connection between the actuator and a medium plate of the actuator-integrated vibration sound device according to an embodiment of the present invention.

FIG. 5 illustrates a cross-section taken along line Y–Y in a state in which the middle case 100 and the second medium plate 300 are removed.

Referring to FIG. 5, magnet parts 810 are disposed on both sides of the coil plate 820, and the coil plate 820 is disposed between the magnet parts 810. The coil plate 820 has a lower end fitted into and fixedly coupled to a coil plate connector 220 of the first medium plate 200 and an upper end passing through an insertion hole 910 of the cover plate 900.

In addition, the metal suspension 830 is fastened at both sides by suspension bolts 30 through a first fastening portion 850 of the metal suspension 830 and a second fastening portion 720 of the side case 700.

Through the metal suspension 830 and the side case 700, the actuator 800 and the first medium plate 200 are integrally coupled, such that vibration of the actuator 800 is directly transmitted to the outside through the first medium plate 200, thereby allowing sound and vibration to be transmitted without distortion.

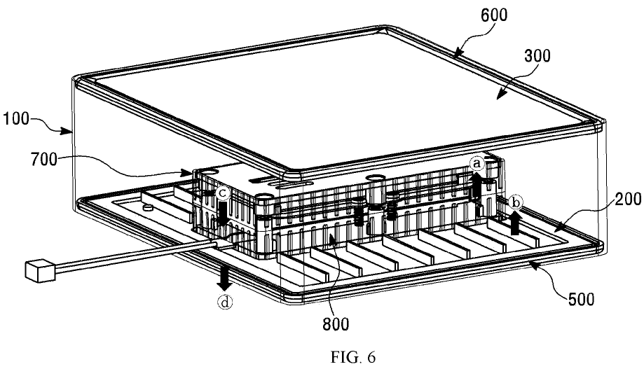

FIG. 6 is a structural view illustrating first and second medium plates of the actuator-integrated vibration sound device according to an embodiment of the present invention.

Referring to FIG. 6, the actuator 800 is integrally connected to a central portion of the first medium plate 200, and vibration is directly transmitted to the first medium plate 200 integrally connected thereto according to vertical vibration of the actuator 800.

In this case, the actuator 800 constitutes the actuator assembly 400, and the second medium plate 300 is disposed above the actuator 800.

The actuator 800 is integrally connected to the first medium plate 200, and the second medium plate 300 is correspondingly disposed above the first medium plate 200, while the middle case 100 is disposed between the first and second medium plates 200 and 300.

The middle case 100 and the first and second medium plates 200 and 300 may be coupled via first and second rubber edges 500 and 600, respectively.

The actuator 800 vertically vibrates by operation of the magnetic circuit, and the vibration is directly transmitted to the first medium plate 200 integrally connected to the actuator 800.

In this case, when the actuator 800 vibrates in the direction of arrow ⓐ, air inside the middle case 100 is momentarily compressed (in the direction of arrow ⓑ) by vibration transmitted to the first medium plate 200. Conversely, when vibration (wave) of the actuator 800 operates in the direction of arrow ⓒ, the air inside the middle case 100 is momentarily expanded (in the direction of arrow ⓓ) by vibration of the first medium plate 200.

Accordingly, as the actuator 800 vertically vibrates, the air inside the middle case 100 repeatedly undergoes expansion and compression. In this case, since the second medium plate 300 is also sealed and attached to the middle case 100 via the second rubber edge, the second medium plate 300 naturally vibrates in response to changes in air pressure within the middle case 100.

As a result, the second medium plate 300 reproduces sound by functioning as a passive radiator in response to the internal air pressure changes caused by vertical vibration (waves), thereby reinforcing reproduction of mid- and low-frequency sounds.

As described above, since the vibration and sound device 10 according to the present invention does not include speaker holes or a grille on front and rear surfaces of an entirely sealed enclosure, the vibration and sound device 10 may be used as an innovative outdoor speaker having excellent waterproof performance.

In addition, by integrally coupling the actuator and the medium plates, sound distortion is not generated, and various slim and curved designs may be implemented, and various forms of printing and film attachment may be applied to the first and second medium plates.

According to the above-described configuration of the present invention, the present invention may provide the innovative outdoor-type vibration and sound device having excellent waterproof performance may be provided, because the speaker holes or grills are not provided on the front and rear surfaces.

In addition, the present invention may provide the vibration and sound device in which the sound distortion is not generated through the structure in which the medium plate and the magnetic circuit are integrally coupled, and in which the role as the passive radiator is induced through boxing of the front and rear medium plates.

Further, the present invention may provide the ultra-slim vibration and sound device having the haptic function that actively responds to the development of various haptic device products that implement the tactile sensation, such as a haptic glove.

However, the effects of the present invention are not limited to the aforementioned benefits and may be variously extended without departing from the spirit and scope of the invention.

The features, structures, and effects described in the above embodiments are included in at least one embodiment of the present invention and are not necessarily limited to a single embodiment. Furthermore, the features, structures, and effects exemplified in each embodiment may be combined or modified with respect to other embodiments by those having ordinary skill in the art to which the embodiments pertain. Accordingly, such combinations and modifications should be construed as being included within the scope of the present invention.

### Description of reference numerals

10: Vibration sound device

20: Lead plate

30: Suspension bolt

40: Column bolt

100: Middle case

200: First medium plate

300: Second medium plate

400: Actuator assembly

500: First rubber edge

600: Second rubber edge

700: Side case

800: Actuator

900: Cover plate

What is claimed is:

1. An actuator-integrated vibration sound device comprising:
an actuator assembly comprising a magnetic circuit disposed therein and configured to generate vertical vibration of an actuator;
a first medium plate connected to a lower portion of the actuator assembly and configured to transmit vibration from the actuator;
a second medium plate spaced a predetermined distance from the first medium plate; and
a middle case having one end connected to the first medium plate and the other end connected to the second medium plate.

2. The actuator-integrated vibration sound device of claim 1, wherein the first and second medium plates and the middle case are connected via first and second rubber edges, respectively.

3. The actuator-integrated vibration sound device of claim 1, wherein a plurality of linear ribs or radial ribs are disposed on opposing surfaces of the first and second medium plates.

4. The actuator-integrated vibration sound device of claim 1, wherein a coil plate connector into which a coil plate of the actuator is fitted is disposed on one surface of the first medium plate,
a lead wire terminal electrically connected to the coil plate connector is provided, and
a lead plate configured to apply external power is coupled to the lead wire terminal.

5. The actuator-integrated vibration sound device of claim 1, wherein the actuator comprises a pair of opposing magnet parts and a coil plate disposed therebetween in an upright manner,
both ends of each of the pair of magnet parts are fitted into and coupled to the assembly, and
a metal suspension coupled to the assembly is provided to transmit vibration to both sides.

6. The actuator-integrated vibration sound device of claim 1, wherein the actuator assembly has a lower portion in contact with the first medium plate and an upper portion covered by a cover plate and comprises an actuator disposed therein and a side case disposed on an outer side thereof.

7. The actuator-integrated vibration sound device of claim 6, wherein a plurality of column posts having screw taps are disposed on one surface of the first medium plate, and
connection posts are disposed on a bottom surface of the cover plate at positions corresponding to the column posts.

8. The actuator-integrated vibration sound device of claim 6, wherein left and right metal suspensions configured to transmit vibration are disposed on both sides of the actuator,
a first fastening portion is disposed at a central portion of each of the metal suspensions, and a second fastening portion is disposed on an inner side of the side case at a position corresponding to the first fastening portion, and
a connecting ring into which a column bolt is insertable is disposed on the inner side of the side case between the column posts and the connection posts.

9. The actuator-integrated vibration sound device of claim 1, wherein the first and second medium plates and the middle case are connected via first and second rubber edges, respectively, to seal an internal predetermined space, and
the second medium plate serves as a passive radiator due to compression and expansion of air within the internal space caused by vibration of the first medium plate according to vertical vibration of the actuator.

10. An actuator-integrated vibration sound device comprising:
an actuator assembly comprising a side case surrounding an exterior of the actuator assembly and having a lower portion in contact with the first medium plate and an upper portion covered by a cover plate, and an actuator disposed in the side case and comprising a magnetic circuit comprising a pair of opposing magnet parts and a coil plate disposed therebetween in an upright manner and metal suspensions disposed on left and right sides thereof and configured to transmit vertical vibration of the pair of magnet parts; and
a medium plate connected to a lower portion of the actuator assembly and made of a plate-shaped plastic material having elasticity, the medium plate being configured to integrally transmit vibration from the actuator.
